(19) United States
(12) Patent Application Publication
(10) Pub. No.: US 2008/0077756 A1
(43) Pub. Date: Mar. 27, 2008

(54) Information processing system and computer readable medium

(75) Inventor: Yayoi Shibata, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/783,453

(22) Filed: Apr. 10, 2007

(30) Foreign Application Priority Data
Sep. 27, 2006 (JP) 2006-261780

(51) Int. Cl. G06F 12/00

(52) U.S. Cl. 711/156

(57) ABSTRACT

An information processing system includes: a storage that stores information and at least one attribute of the information; and an access right setting unit that sets an access right for each attribute stored in the storage.

### CROSS-REFERENCE TO RELATED APPLICATIONS

This application is based on and claims priority under 35 U.S.C. 119 from Japanese Patent Application No. 2006-261780 filed Sep. 27, 2006.

### BACKGROUND

1. Technical Field

This invention relates to an information processing system and a computer readable medium.

2. Related Art

At present, to manage data electronized by a computer, an information processing system adopts an information management method of setting the access right in the relationship between the user and an object (data, information) and granting permission to perform operation defined for the access right only to the user having the access right. It is a common practice to define a group, a set of users, and setting the access right for the group, thereby making it possible to easily set the access right. The access refers to data read or data write from or into storage with a computer (the storage contains memory, etc., and is not necessarily included in the computer).

Each of the electronized objects is given properties (attributes) of a title, the creation date and time, a summary, description, etc., and generally display of the properties is controlled according to the access right of the object. This means that an object and its properties are handled integrally with respect to the access right. Specifically, the user permitted to read an object can reference all properties given to the object and the user permitted to edit an object can edit all properties of the object. Thus, in related arts, which of the properties given to an object the user is allowed to display/edit cannot be controlled for each user.

### SUMMARY

According to an aspect of the present invention, an information processing system includes: a storage that stores information and at least one attribute of the information; and an access right setting unit that sets an access right for each attribute stored in the storage.

### BRIEF DESCRIPTION OF THE DRAWINGS

Exemplary embodiment of the present invention will be described in detail based on the following figures, wherein:

FIG. 1 is a schematic block diagram to illustrate the module configuration of an embodiment of the invention;

FIG. 2 shows an example of an access right list to documents;

FIG. 3 shows an example of an access right list to properties;

FIG. 4 shows an example of a document access right list;

FIG. 5 shows an example of a data aggregate;

FIG. 6 shows an example of an evaluation property access right list;

FIG. 7 shows examples of display and edit property lists;

FIG. 8 shows a display example of document properties;

FIG. 9 is a flowchart to show a procedure example of determining display and edit properties; and

FIG. 10 is a schematic block diagram to illustrate the hardware of the embodiment of the invention.

### DETAILED DESCRIPTION

To begin with, to facilitate understanding of an embodiment, an outline of the embodiment will be discussed.

Preferably, property display/non-display and edit permission/non-permission can be set flexibly according to the access right to an object and can also be set easily.

The embodiment is intended for meeting the demands according to two arts. One is to give the access right to each of properties given to an object and the other is to set an access right list given to the properties as to what access right is assigned to the object rather than the user or group.

If the access right is set for one property, the access right to the property is reflected on all objects using the object and thus the need for setting the access right for each object is eliminated. An access right list to the properties is set as to what access right is assigned to the objects, whereby it is made possible to automatically and flexibly change property display/non-display and edit permission/non-permission in response to the access right to each object.

Referring now to the accompanying drawings, there is shown an exemplary embodiment of the invention.

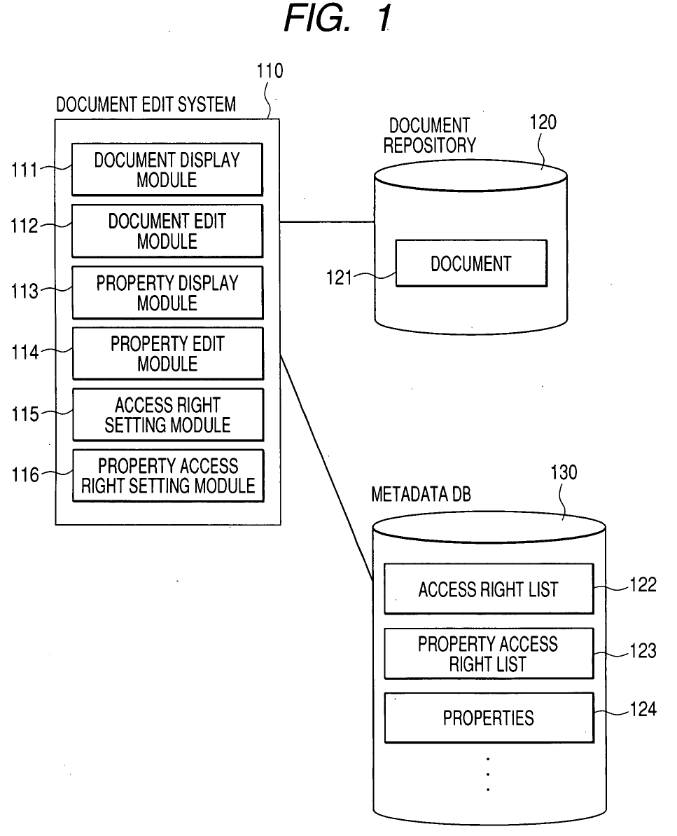

The accompanying drawings show the embodiment of the invention. FIG. 1 is a block diagram to show the conceptual module configuration of the embodiment.

A module refers generally to a logically detachable part of software, hardware, etc. Therefore, the module in the embodiment means not only a module in a program, but also a module in the hardware configuration. Therefore, the embodiment also serves as the description of a program, a system, and a method. Modules are almost in a one-to-one correspondence with functions; however, in implementation, one module may be one program or two or more modules may make up one program or two or more programs may make up one module. Two or more modules may be executed by one computer or one module may be executed in two or more computers in a distributed or parallel environment. In the description to follow, the term “connection” contains not only physical connection, but also logical connection.

The system is not only provided by connecting a plurality of computers, hardware components, units, etc., through a network, etc., but also implemented as one computer, one hardware component, one unit, etc.

To realize access to a storage section by a program, the program becomes a module program for controlling so as to store, etc., in the storage section.

In the description to follow, a document is mainly illustrated as an object.

The embodiment has a document edit system 110, a document repository 120, and a metadata DB 130. The document repository 120 and the metadata DB 130 may be managed as one database.

The document edit system 110 contains a document display module 111, a document edit module 112, a property display module 113, a property edit module 114, an access right setting module 115, and a property access right setting module 116. The document repository 120 stores a document 121 and the metadata DB 130 stores an access right list 122, a property access right list 123, properties 124, etc.

The document edit system 110 and the document repository 120 are connected and the modules in the document edit system 110 can access various pieces of data in the document repository 120. Likewise, the document edit system 110 and the metadata DB 130 are connected and the modules in the document edit system 110 can access various pieces of data in the metadata DB 130.

The document display module 111 displays the contents of the document 121 stored in the document repository 120 on a display section of a display, etc. Whether or not the document can be displayed is determined according to the access right list 122 in the metadata DB 130 corresponding to the document 121. That is, if the operator who attempts to display the document does not have the read right of the document 121, displaying the document is prohibited.

The document edit module 112 edits the contents of the document 121 stored in the document repository 120 in response to operation of the operator. Whether or not the document can be edited is determined according to the access right list 122 in the metadata DB 130 corresponding to the document 121. That is, if the operator who attempts to edit the document does not have the write right of the document 121, editing the document is prohibited.

The property display module 113 displays the descriptions of the properties 124 in the metadata DB 130 corresponding to the target document 121 on the display section of a display, etc. Whether or not the descriptions of the properties can be displayed is determined according to setting of the property access right setting module 116 or the property access right list 123 in the metadata DB 130 corresponding to the document 121 storing the setting. That is, if the operator who attempts to display the descriptions of the properties does not have the read right of the properties 124 in the metadata DB 130 corresponding to the document 121, displaying the properties is prohibited. In the description to follow, the properties 124 in the metadata DB 130 corresponding to the document 121 may be properties of the document 121 (document properties) or may be properties of information (for example, text) in the document 121 (text properties).

The property edit module 114 edits the descriptions of the properties 124 in the metadata DB 130 corresponding to the target document 121 in response to operation of the operator. Whether or not the descriptions of the properties 124 can be edited is determined according to setting of the property access right setting module 116 or the property access right list 123 in the metadata DB 130 corresponding to the document 121 storing the setting. That is, if the operator who attempts to edit the descriptions of the properties does not have the write right of the properties 124 in the metadata DB 130 corresponding to the document 121, editing the properties is prohibited.

The access right setting module 115 sets the access right to the document 121 in response to operation of the operator. The setup result is stored in the access right list 122 in the metadata DB 130 corresponding to the document 121.

The property access right setting module 116 sets the access right to the properties 124 in the metadata DB 130 corresponding to the target document 121 in response to operation of the operator or the access right to the document 121. The setup result is stored in the property access right list 123 in the metadata DB 130 corresponding to the document 121. The access right is set for each of the properties.

The document 121 is a document to be edited by the document edit module 112, etc. The properties 124 exist in the metadata DB 130 corresponding to the document 121. One or more properties may exist.

The access right list 122 is a list storing the access right to the document 121.

The property access right list 123 is a list storing the access right to the properties of the document 121.

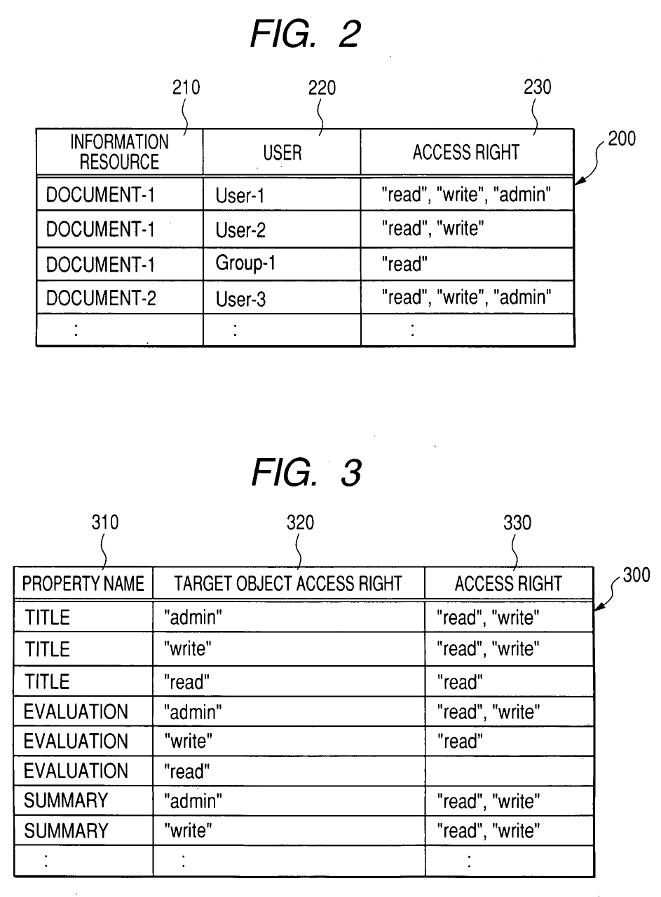

The access right list to documents of objects will be discussed with an example shown in FIG. 2.

An access right list 200 as in FIG. 2 is associated with documents. When one document is created, the document access right list 200 is assigned to the document. A property access right list 300 as in FIG. 3 is associated with properties. The property access right list 300 is assigned to the properties registered in the system. To create a new property, the property can be set in the property access right list at the property creating time and can also be edited.

The document access right list 200 shown in FIG. 2 is a list of sets of entries of information resources stored in an information resource column 210, users stored in a user column 220, and access rights stored in an access right column 230.

The information resources are objects (for example, document-1, document-2, etc.,). The access right is set for each of the objects.

The user in the user column 220 has the access right set for the information resource corresponding to the user. Of course, not only the user, but also a group may be stored in the user column 220. In the description to follow, the term “user” is used in a wide sense containing a group unless expression “user or group” is specified.

The access right is the right given to the user with respect to the information resources; “read” means the read right; “write” means the write right; and “admin” means the administration right. The read right, the write right, and the administration right have the inclusive relationship; the user having “write” right also has the “read” right and the user having “admin” right also has the “write” right and the “read” right.

If the access rights are set as in the document access right list 200 shown in FIG. 2, it means that User-1 has the read right, the write right, and the administration right of document 1, that User-2 has the read right and the write right of document 1, and that Group-1 has only the read right.

The property access right list 300 will be discussed with an example shown in FIG. 3.

The property access right list 300 shown in FIG. 3 is a list of sets of entries of property names stored in a property name column 310, target object access rights stored in a target object access right column 320, and access rights stored in an access right column 330.

The property name column 310 lists the properties given to the target document. In FIG. 3, a plurality of properties are shown.

The access right to the target document is set in the target object access right column 320.

As the access right, “read” means the read right; “write” means the write right; and “admin” means the administration right.

If the access rights are set as in the property access right list 300 shown in FIG. 3, it indicates that the read right (“read”) and the write right (“write”) of the “title” property are given to the user and the group having “admin” and “write” as the object access right and the read right (“read”) is given to the user and the group having “read.” The list also indicates that the read right (“read”) and the write right (“write”) of the “evaluation” property are given to the user and the group having “admin” as the object access right, that only the read right (“read”) is given to the user and the group having “write” as the object access right, and that neither the read right nor the write right is given to other users, other groups.

The property display module 113 or the property edit module 114 uses the document access right list 200 and the property access right list 300 to determine which property is to be displayed or is permitted to be edited for each accessing user.

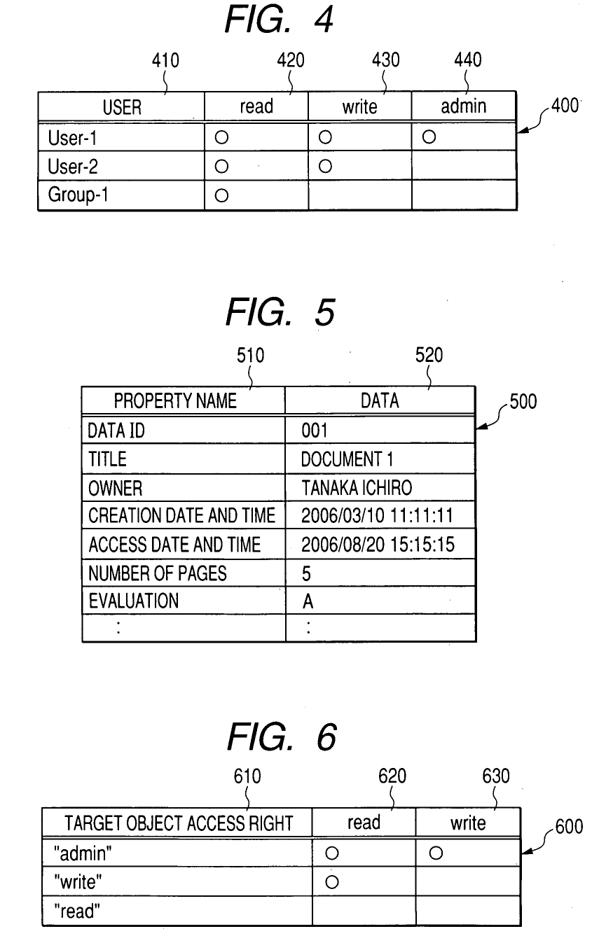

The document access right list will be discussed with an example shown in FIG. 4. Access right 400 to document 1 is created based on the document access right list 200.

The access right 400 to document 1 is a list of sets of entries of users stored in a user column 410, a symbol indicating that the user has the “read” right stored in a read column 420, a symbol indicating that the user has the “write” right stored in a write column 430, and a symbol indicating that the user has the “admin” right stored in an admin column 440.

Specifically, the access right 400 to document 1 shown in FIG. 4 represents that User-1 has the “read” right, the “write” right, and the “admin” right of the document 1, that User-2 does not have the “admin” right although the user has the “read” right and the “write” right, and that Group-1 has only the “read” right.

A data aggregate will be discussed with an example shown in FIG.5. The data aggregate is a list of properties and values of a target document.

A data aggregate 500 shown in FIG. 5 is a list of sets of entries of property names stored in a property name column 510 and data stored in a data column 520. The data is the actual values of the properties. For example, the data of property name “owner” is “TANAKA Ichiro.”

The relation between the access right to a target document and the access right to one property of the document will be discussed with an example shown in FIG. 6.

The access right 600 to an evaluation property is a list of sets of entries of the access right to the target document in a target object access column 610, a symbol indicating that the user has the “read” right stored in a read column 620, and a symbol indicating that the user has the “write” right stored in a write column 630.

Specifically, the access right 600 to an evaluation property shown in FIG. 6 represents that if the user has the “admin” right as the access right to the target document, the user also has the “read” right and the “write” right of one property; if the user has the “write” right as the access right to the target document, the user has the “write” right of one property; and if the user has the “read” right as the access right to the target document, the user has neither the “read” right nor the “write” right of the property.

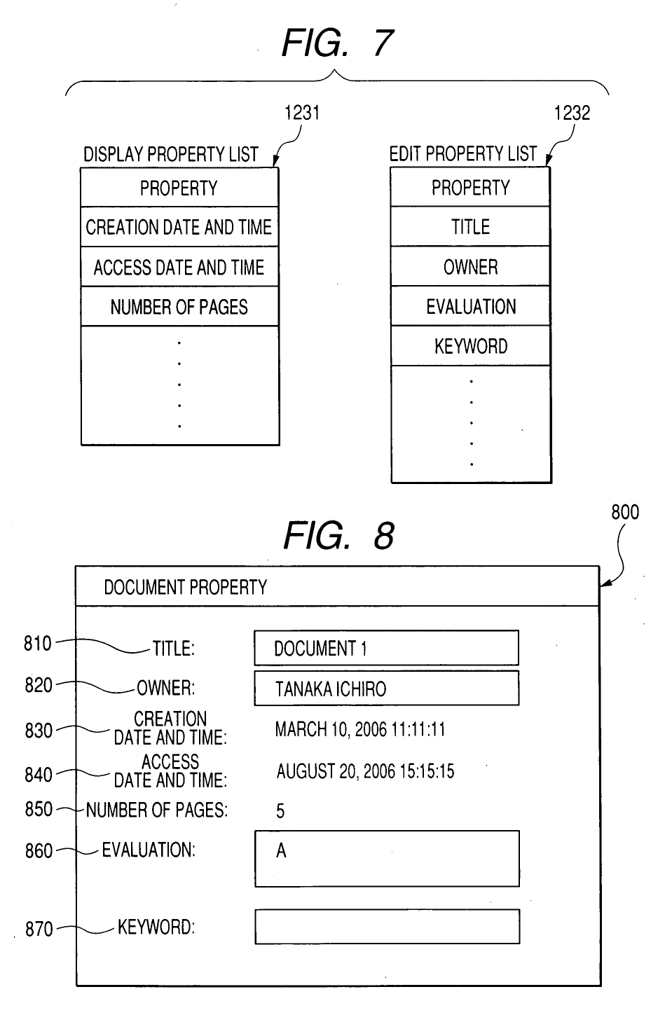

A list of displayable properties and a list of editable properties will be discussed with an example shown in FIG. 7.

A display property list 1231 shown in FIG. 7 is a list of displayable properties; for example, it indicates that the creation date and time, the access date and time, and the number of pages can be displayed. An edit property list 1232 is a list of editable properties; for example, it indicates that the title, the owner, the evaluation, and the keyword can be edited. If the properties can be edited, they can also be displayed.

The property access right list 123 in the metadata DB 130 shown in FIG. 1 has the display property list 1231 and the edit property list 1232. The property display module 113 references the display property list 1231 and displays the properties. The property edit module 114 references the edit property list 1232 and edits the properties whose edit is permitted.

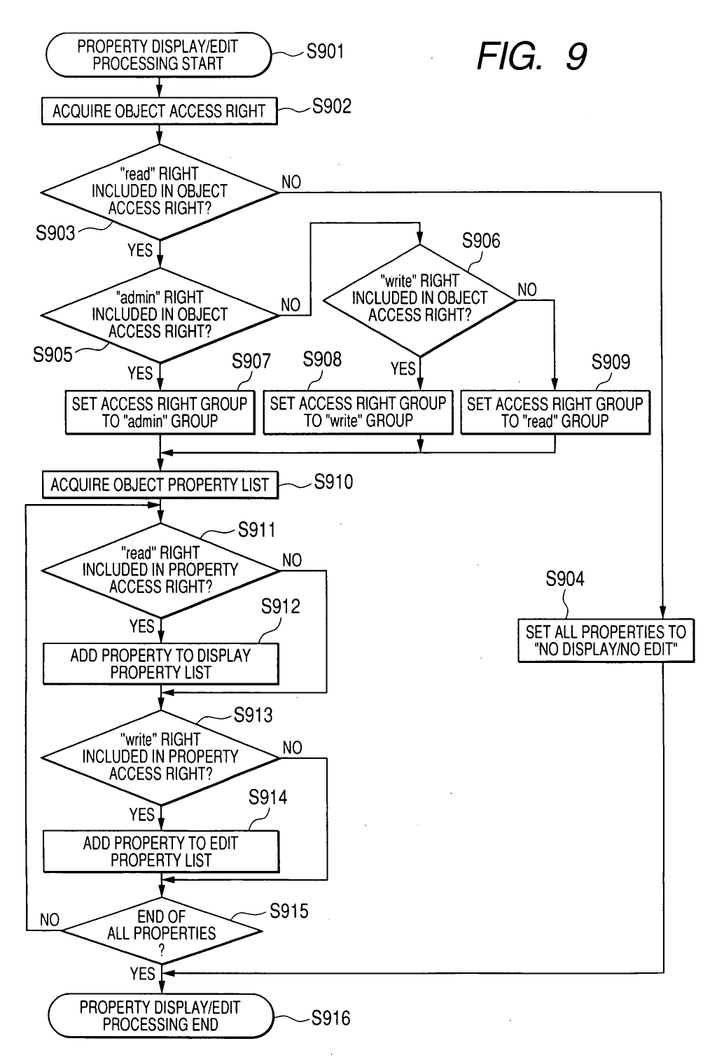

Display of the document properties will be discussed with an example shown in FIG. 8.

Document properties 800 shown in FIG. 8 are displayed by the property display module 113 based on the display property list 1231 and the edit property list 1232. That is, since the display property list 1231 contains the creation date and time, the access date and time, and the number of pages and the edit property list 1232 contains the title, the owner, the evaluation, and the keyword, a title entry 810, an owner entry 820, a creation date and time entry 830, an access date and time entry 840, a number of pages entry 850, an evaluation entry 860, and a keyword entry 870 are displayed in the document properties 800, the creation date and time entry 830, the access date and time entry 840, and the number of pages entry 850 cannot be edited, and the title entry 810, the owner entry 820, the evaluation entry 860, and the keyword entry 870 can be edited.

Next, the operation is as follows:

FIG. 9 is a flowchart to show a procedure of determining property display/edit.

An outline of displaying/editing the document properties will be discussed. To begin with, the access right to a document is acquired and information as to which access right group the accessing user belongs to is acquired. Next, a list of the document properties is acquired and what authorities the setup group has about each property is checked and display/edit of each property is determined.

The details are as follows:

At step S902, the access right to the document of a target object is acquired.

At step S903, whether or not the access right to the document acquired at step S902 includes the “read” right is determined. If the access right includes the “read” right, the process goes to step S905; if the access right does not include the “read” right, the process goes to step S904.

At step S904, the access right to all properties given to the document is set to “no display (display prohibited)” and “no edit (edit prohibited).” This means that neither the “read” right nor the “write” right is set.

At step S905, whether or not the access right to the document acquired at step S902 includes the “admin” right is determined. If the access right includes the “admin” right, the process goes to step S907; if the access right does not include the “admin” right, the process goes to step S906.

At step S906, whether or not the access right to the document acquired at step S902 includes the “write” right is determined. If the access right includes the “write” right, the process goes to step S908; if the access right does not include the “write” right, the process goes to step S909.

At step S907, the access right group is set to “admin” group.

At step S908, the access right group is set to “write” group.

At step S909, the access right group is set to “read” group.

At step S910, a list storing all properties of the target document (the property name column 510 in the data aggregate 500) is acquired. Steps S911 to S915 are executed for each of the properties in the list.

At step S911, whether or not the access right to the target property includes the “read” right is determined using the group determined at step S907, S908, or S909 and the property access right list 300. If the access right includes the “read” right, the process goes to step S912; if the access right does not include the “read” right, the process goes to step S913.

At step S912, the target property is added to the display property list 1231.

At step S913, whether or not the access right to the target property includes the “write” right is determined using the group determined at step S907, S908, or S909 and the property access right list 300. If the access right includes the “write” right, the process goes to step S914; if the access right does not include the “write” right, the process goes to step S915.

At step S914, the target property is added to the edit property list 1232.

At step S915, whether all properties in the list acquired at step S910 have been processed is determined. If processing of all properties is complete, the process goes to step S916 (end); if processing is not complete, the process returns to step S911.

For example, assume that the access right like the access right 400 to document 1 shown in FIG. 4 is set in the document 1. If User-2 accesses the document 1, although User-2 does not have the admin authority of the document 1, User-2 has the write authority and thus is defined as “write” group (step S908).

Next, for each of the properties of the document 1, what authority the “write” group has for the property is checked (steps S911 and S913). For example, if the evaluation property is given to the document 1 (see the data aggregate 500 in FIG. 5) and is assigned the access right like the access right 600 to an evaluation property shown in FIG. 6, the “write” group has the “read” authority and thus the evaluation property can be displayed. However, since the “write” authority is not included, the evaluation property cannot be edited. Thus, all properties of the document 1 are checked (step S915) and display of the property assigned the “read” authority is permitted (step S912) and edit of the property assigned the “write” authority is permitted (step S914).

The access right is set for each property as described above, so that intricacy of setting property display/edit for each object as in the related art method can be eliminated. For the access right to each property, the user group having the object access right (for example, “admin” group, “write” group, “read” group) rather than the user or the group is specified, whereby property display/edit is also automatically changed simply by changing the object access right, so that it is made possible to save the user from having to set the access right.

In the embodiment, the document is shown as the object, but the object may be not only the document, but also a device, etc.

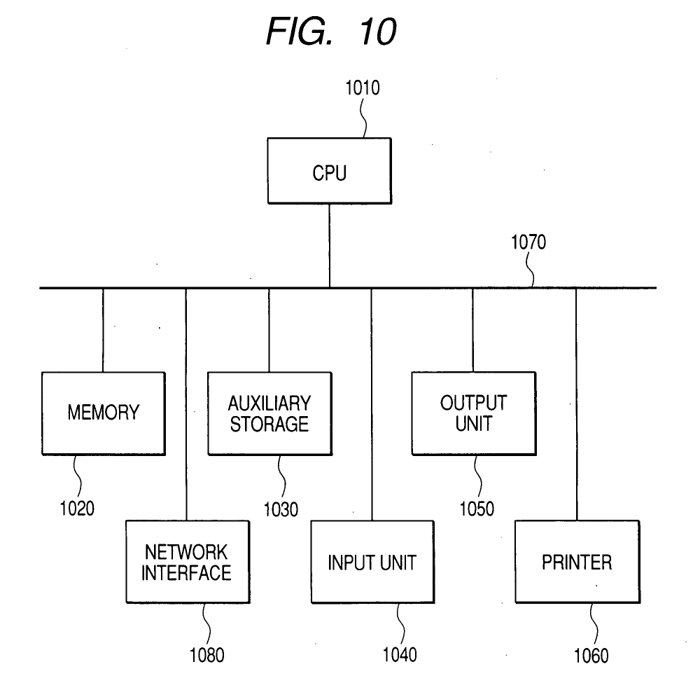

The computer in which the embodiment is executed is a general computer, such as a personal computer, as shown in FIG. 10. The computer system is made up of a CPU 1010 for executing the modules of the document display module 111, the document edit module 112, the property display module 113, the property edit module 114, the access right setting module 115, the property access right setting module 116, etc., memory 1020 for storing the programs and data of documents, attributes thereof, etc., auxiliary storage 1030 implemented as an HDD, etc., an input unit 1040 for entering data through a keyboard, a mouse, etc., an output unit 1050 of a CRT, a liquid crystal display, etc., a printer 1060 for outputting the result, etc., onto paper, etc., a network interface 1080 for communicating with a client, and a bus 1070 for connecting the components for transferring data. Two or more computers may be connected by a network.

The hardware configuration shown in FIG. 10 shows one configuration example and the embodiment is not limited to the configuration in FIG. 10 and any configuration may be adopted if it makes it possible to execute the modules described in the embodiment. For example, some modules may be implemented as dedicated hardware (for example, an ASIC, etc.,) and some modules may be included in an external system and may be connected via a communication line and further a plurality of systems shown in FIG. 10 may be connected via a communication line so as to operate in cooperation with each other. The system may be built in a copier, a fax, a scanner, a printer, a multifunction processing machine (also called a multifunction copier, having the functions of a scanner, a printer, a copier, a fax, etc.,), etc.

The program in the embodiment described above can also be stored on a computer-readable record medium recording the program or can also be provided via a communication line.

The expression “computer-readable record medium recording a program” is used to mean a record medium read by a computer recording a program, used to install and execute a program, to distribute a program, etc.

The record media include “DVD-R, DVD-RW, DVD-RAM, etc.,” of digital versatile disk (DVD) and standard laid down in DVD Forum, “DVD+R, DVD+RW, etc.,” of standard laid down in DVD+RW, read-only memory (CD-ROM), CD recordable (CD-R), CD rewritable (CD-RW), etc., of compact disk (CD), magneto-optical disk, flexible disk (FD), magnetic tape, hard disk, read-only memory (ROM), electrically erasable and programmable read-only memory (EEPROM), flash memory, random access memory (RAM), etc., for example.

The described program or a part thereof can be recorded in any of the described record media for retention, distribution, etc. The described program or a part thereof can also be transmitted by communications using a transmission medium such as a wired network used with a local area network, a metropolitan area network (MAN), a wide area network (WAN), the Internet, an intranet, an extranet, etc., or a wireless communication network or a combination thereof, etc., for example, and can also be carried over a carrier wave.

Further, the described program may be a part of another program or may be recorded in a record medium together with a different program.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An information processing system comprising:
a storage that stores information and at least one attribute of the information; and
an access right setting unit that sets an access right for each attribute stored in the storage.

2. The information processing system as claimed in claim 1, wherein the access right setting unit sets the access right for each attribute in response to the access right to the information.

3. The information processing system as claimed in claim 2, further comprising:
an information display that displays the information stored in the storage on a display;
an information edit unit that edits the information stored in the storage;
an attribute display that displays the attribute stored in the storage on the display in response to the access right set for the attribute; and
an attribute edit unit that edits the attribute stored in the storage in response to the access right set for the attribute.

4. An information processing system comprising:
an access right storage that associates operator information with an access right in association with information stored in a storage, and that stores the operator information and the access right associated with each other; and
an attribute access right setting unit that sets an access right to an attribute of the information in response to the access right to the information stored in the access right storage.

5. The information processing system as claimed in claim 4, wherein the attribute access right setting unit sets the access right to each of a plurality of attributes of the information.

6. An information processing system comprising:
an access right storage that associates operator information with a first access right in association with information stored in a storage, and that stores the operator information and the first access right associated with each other; and
an attribute access right storage that associates the first access right with a second access right to an attribute of the information in association with the attribute of the information, and that stores the first access right and the second access right associated with each other; and
an attribute display determination unit that determines whether or not to display or edit the attribute of the information in response to the first access right and the second access right.

7. A computer readable medium storing a program causing a computer to execute a process for performing an information processing, the process comprising:
storing information and at least one attribute of the information in a storage section; and
setting an access right for each attribute stored in the storage section.

8. The computer readable medium as claimed in claim 7, wherein the setting of the access right comprises setting the access right in response to an access right to the information.

9. The computer readable medium as claimed in claim 8, further comprising:
displaying the information stored in the storage section;
editing the information stored in the storage section;
displaying the attribute stored in the storage section in response to the access right set for the attribute; and
editing the attribute stored in the storage section in response to the access right set for the attribute.

10. A computer readable medium storing a program causing a computer to execute a process for performing an information processing, the process comprising:
associating operator information with an access right in association with information stored in a storage, and storing the operator information and the access right associated with each other; and
setting an access right to an attribute of the information in response to the access right to the information.

11. The computer readable medium as claimed in claim 10, wherein the setting of the access right comprises setting the access right to each of a plurality of attributes of the information.

12. A computer readable medium storing a program causing a computer to execute a process for performing an information processing, the process comprising:
associating operator information with a first access right in relation to information stored in a storage, and storing the operator information and the first access right associated with each other;
associating the first access right and a second access right to an attribute of the information in association with the attribute of the information; and
determining whether or not to display or edit the attribute of the information in response to the first access right and the second access right.

13. The processing system as claimed in claim 1, wherein
the information is an electronic document;
the attribute is at least one of an attribute of the document and an attribute of text in the document.
